(19) United States
(12) Patent Application Publication
(10) Pub. No.: US 2014/0279081 A1
(43) Pub. Date: Sep. 18, 2014

(54) MOBILE DEVICES, METHODS AND COMPUTER SYSTEMS FOR ENSURING THAT A PICKUP ORDER IS FRESHLY PREPARED WHEN A CONSUMER ARRIVES TO PICK IT UP

(71) Applicant: QUALCOMM INCORPORATED, San Diego, CA (US)

(72) Inventors: Peter S. Marx, San Diego, CA (US); Eric P. Bilange, San Diego, CA (US); Ian R. Heidt, Carlsbad, CA (US)

(73) Assignee: QUALCOMM Incorporated, San Diego, CA (US)

(21) Appl. No.: 13/833,931

(22) Filed: Mar. 15, 2013

(51) Int. Cl. G06Q 30/06; G06Q 50/12

(52) U.S. Cl. CPC G06Q 30/0601; G06Q 50/12
USPC 705/15

(57) ABSTRACT

A C-A MD uses contextual awareness to sense its surroundings and determine spatial relationships between the C-A MD and each of a plurality of retail food establishments. Based on these determinations, the C-A MD determines which of the establishments the user is most likely to arrive at to pick up an order. Based on this determination, the C-A MD places a pickup order with the particular establishment and/or sends a notification to the particular establishment that the user will likely ultimately arrive at the particular establishment to pick up the order. Based on the order or the notification received by the establishment, a preparer at the establishment can perform tasks associated with the order to ensure that the order is freshly prepared when the consumer arrives to pick up the order.

### TECHNICAL FIELD OF THE INVENTION

The invention relates to mobile devices, and more particularly, to a mobile device that uses information known to the mobile device about its surroundings to place an order or send a notification associated with an order to one of a plurality of establishments.

### BACKGROUND OF THE INVENTION

In the retail food industry, many retail suppliers of perishable products (e.g., restaurants) allow consumers to place orders that they will pick up at the retail supplier's establishment. Ideally, the perishable product ordered should be freshly prepared at the time that the consumer arrives at the establishment to pick up the order. Often times, consumers place orders with retail suppliers by telephone or computer. At the time that the order is placed, the retail supplier often asks the consumer for the time of day that the consumer will arrive to pick up the order. Given the estimated time of arrival of the consumer, the retail supplier will attempt to have the order freshly prepared at the time that the consumer actually arrives at the establishment to pick up the order.

One of the difficulties that retail suppliers of perishable products face is choosing a point in time to begin preparation of a food order that ensures that the order is freshly prepared when the consumer arrives to pick up the order. For example, in cases where preparation involves combining ingredients and cooking a food product, the establishment ideally begins preparing the order at a point in time that is in advance of the expected arrival time by a time period equal to the length of time required to prepare the food product. In other words, the point in time at which preparation of the food product has been completed ideally coincides with the point in time at which the consumer arrives at the establishment to pick up the order.

A wide variety of events may occur that prevent the point in time at which preparation of the food product has been completed from coinciding with the point in time at which the consumer arrives at the establishment to pick up the order. Some of these events prevent the consumer from arriving at the expected pickup time, such as traffic jams, automobile problems, faulty time management, and unreliability of the consumer. On the other hand, events may occur that prevent the establishment from completing preparation of the order at the expected pickup time, such as faulty time management by the preparer, difficulties with obtaining the proper ingredients, equipment malfunctions, and employee problems. Because of a relatively high probability that one or more of these events will occur, perishable products often are not fresh and/or hot at the time that the consumer arrives at the establishment to pick up the order.

Accordingly, a need exists for a mobile device and method that ensure that an order is freshly prepared when the consumer arrives to pick up the order.

### SUMMARY OF THE INVENTION

The invention is directed to a mobile device configured to order items, methods performed by the mobile device to order items, a computer-readable medium that stores code used by the mobile device to perform the methods, and computer systems and methods used at retail establishments for scheduling tasks associated with preparing items ordered by the mobile device. The mobile device comprises an input/output (I/O) interface, at least one input element coupled to the I/O interface for receiving input entered on the input element by a user, a radio frequency (RF) subsystem configured to allow the mobile device to communicate wirelessly over a telecommunications network, at least one memory device, and at least one processor electrically coupled to the I/O interface, to the RF subsystem and to the memory device. The RF subsystem includes an RF antenna, a receiver (Rx) module and a transmitter (Tx) module.

In accordance with one illustrative embodiment of the mobile device, the processor is configured to determine spatial relationships between the mobile device and each of a plurality of establishments and to use the spatial relationships to determine one establishment of the plurality of establishments that is convenient for the user and transmits a pickup order to the determined one of the plurality of establishments.

The method, in accordance with an illustrative embodiment, comprises:

on the mobile device, receiving an order from a user of the mobile device that specifies an item requiring preparation time and being available at a plurality of establishments;

determining, on the mobile device, spatial relationships between the mobile device and each of a plurality of establishments associated with a retail entity;

determining, on the mobile device, one of the plurality of establishments convenient for the user to pick up the order based at least in part on the spatial relationships; and

transmitting from the mobile device a pickup order for the item to be picked up at the determined one of the plurality of establishments.

In accordance with another illustrative embodiment of the mobile device, the processor is configured to determine spatial relationships between the mobile device and each of a plurality of establishments associated with the retail entity, to use at least the spatial relationships to determine one establishment of the plurality of establishments convenient to the user of the mobile device, and to transmit a notification to the determined one of the plurality of establishments that a user will arrive at the determined one of the plurality of establishments to pick up a previously-placed order.

The method, in accordance with an illustrative embodiment, comprises:

on the mobile device, receiving an order from a user of the mobile device and causing the order to be placed with a retail entity associated with a plurality of establishments;

on the mobile device, determining spatial relationships between the mobile and each of a plurality of establishments;

on the mobile device, using the spatial relationships to determine one of the establishments convenient for the user to pick up the order based on the spatial relationships; and

on the mobile device, transmitting a notification over a network to notify the determined one of the plurality of establishments that the user of the mobile will arrive at the determined one of the plurality of establishments.

In accordance with another illustrative embodiment of the mobile device, the memory device has historical data stored therein associated with travel routes and retail establishments along the travel routes. The processor collects the historical data, uses the historical data in combination with an estimated pickup time entered on the input device by the user to determine one of the retail establishments that is convenient to the user, and causes the mobile device to transmit an order to the determined one of the plurality of retail establishments.

The method, in accordance with another illustrative embodiment, comprises:

in a mobile device, receiving an item order entered into the mobile device by a user of the mobile device;

in the mobile device, using historical data collected by the mobile device over time to determine one or more retail establishments along a travel route that is convenient to the user;

on the mobile device, displaying the retail establishments on a display device of the mobile device;

in the mobile device, detecting a selection by the user of one of the retail establishments; and

with the mobile device, transmitting a pickup order of the item with the selected retail establishment.

In accordance with an embodiment of the computer system located at the retail establishment, the computer system comprises a display device, a memory device, and a host computer. The host computer executes an order scheduling computer program that receives a notification from a mobile device that a user will arrive at the establishment to pick up a pickup order, creates a schedule of preparation tasks associated with preparing at least one food product of the pickup order, and displays the schedule on the display device for viewing by a preparer of the food product or products.

The method for use by a retail establishment, in accordance with another illustrative embodiment, comprises:

in a host computer of a computer system located at the retail establishment:
receiving a notification from a mobile device that a user will arrive at the establishment to pick up a pickup order;
creating a schedule of preparation tasks associated with preparing at least one food product of the pickup order; and
displaying the schedule on a display device of the computer system for viewing by a preparer of the food product or products.

These and other features and advantages will become apparent from the following description, drawings and claims.

### BRIEF DESCRIPTION OF THE DRAWINGS

FIG. 1 is a block diagram illustrating an example of a C-A MD that has a suitable configuration for performing methods of the invention.

FIG. 2 is a pictorial illustration of a wireless network in which a plurality of establishments are located and in which a consumer equipped with the C-A MD shown in FIG. 1 is located.

FIG. 3 is a flowchart that demonstrates a method performed by the C-A MD shown in FIG. 1 in accordance with an illustrative embodiment.

FIG. 4 is a flowchart that demonstrates a method performed by the C-A MD shown in FIG. 1 in accordance with another illustrative embodiment.

FIG. 5 is a flowchart that demonstrates a method performed by the C-A MD shown in FIG. 1 in accordance with another illustrative embodiment.

FIG. 6 is a flowchart that demonstrates the method performed by the C-A MD shown in FIG. 1 in accordance with another illustrative embodiment.

FIG. 7 is a block diagram of a host computer system located at a retail food establishment that receives notifications from a MD and schedules food preparation tasks that are to be performed to prepare a pickup order.

FIG. 8 is a flowchart that represents an illustrative embodiment of the process performed by the host computer system shown in FIG. 7.

### DETAILED DESCRIPTION OF ILLUSTRATIVE EMBODIMENTS

In accordance with illustrative, or exemplary, embodiments described herein, the term C-A MD (Context-Aware Mobile Device) generally refers to a mobile device equipped with one or more sensors that sense one or more characteristics of the environment in which the mobile device operates, including for example a location, a temperature, a noise environment, or incident light. The C-A MD may be equipped with software that provides a context of the mobile device (and/or the mobile device's user) based on historical analysis of the data output by the one ore more sensors. The embodiments described herein below will focus on using a C-A MD to utilize a context of the mobile device (and/or user) to assist with ordering an item requiring preparation time from one of a plurality of establishments, to identify one of the plurality of establishments that would be convenient for the user of the C-A MD to pick up an order, and to transmit the order to the identified establishment in a manner that facilitates the preparation of the item to be completed at a time coinciding with the arrival of the user at a chosen establishment.

Throughout this process, the C-A MD may be in motion due to the user of the C-A MD being in motion, e.g., traveling in an automobile, in an airplane, on a bicycle, on foot, etc. Because of the motion of the C-A MD, spatial relationships between the C-A MD and each of the establishments is dynamic. Based on real-time determinations that are made by the C-A MD about the spatial relationships, the C-A MD determines which of the establishments the user is most likely to arrive at to pick up an order. The C-A MD then either places an order with the particular establishment if the order has not yet been placed, or, if the order was previously placed with the retail entity, notifies the particular establishment that the user will likely ultimately arrive at the particular establishment to pick up the order. This allows a preparer at the establishment to schedule preparation of the order such that the order is freshly prepared when the consumer arrives to pick up the order.

In accordance with another illustrative embodiment, the C-A MD devices uses historical data collected by a C-A algorithm performed by the C-A MD over time to determine travel routes that the user takes and to determine retail establishments along the travel routes. The user inputs an estimated pickup time into the C-A MD at which the user expects to pick up an order. The C-A MD then uses the historical data and the estimated pickup time to determine retail establishment options along the travel route that the user typically passes during that time of day when traveling along the travel route and displays them on the display device of the C-A MD. The user then selects one of the options for placement of a pickup order.

In accordance with another illustrative embodiment, a host computer located at a retail food establishment executes an order scheduling computer program that (1) receives a notification from a MD that the user will likely ultimately arrive at the particular establishment to pick up an order, (2) schedules preparation tasks associated with the order, and (3) causes the schedule to be displayed on a display device for viewing by the preparer.

FIG. 1 is a block diagram illustrating an example of a C-A MD 100 that has a suitable configuration for performing the methods. The C-A MD 100 may be a “Bluetooth” wireless communication device, a portable cellular telephone, a WiFi-enabled communication device, or any other communication device having wireless communications capabilities. While the C-A MD 100 is not limited to being any particular type of mobile device or having any particular configuration, the C-A MD 100 may be implemented using the MSM8960-based Snapdragon S4 Mobile Development Platform/Smartphone from Qualcomm. The C-A MD 100 illustrated in FIG. 1 is intended to be a simplified example of a cellular telephone capable of determining a context and processing capability for performing methods described herein. One having ordinary skill in the art will understand the operation and construction of a cellular telephone, and, as such, implementation details have been omitted.

In accordance with this illustrative embodiment, the C-A MD 100 includes a baseband subsystem 110 and a radio frequency (RF) subsystem 120 connected together over a system bus 112. The system bus 112 typically comprises physical and logical connections that couple the above-described elements together and enable their interoperability. The RF subsystem 120 may be a wireless transceiver. Although details are not shown for clarity, the RF subsystem 120 generally includes a transmit (Tx) module 130 having modulation, upconversion and amplification circuitry for preparing a baseband information signal for transmission, includes a receive (Rx) module 140 having amplification, filtering and downconversion circuitry for receiving and downconverting an RF signal to a baseband information signal to recover data, and includes a front end module (FEM) 150 that includes diplexer circuitry, duplexer circuitry, or any other circuitry that can separate a transmit signal from a receive signal, as is known to those skilled in the art. An antenna 160 is connected to the FEM 150.

The baseband subsystem 110 generally includes a processor 170, which may be a general purpose or special purpose microprocessor, memory 180, analog circuit elements 116, and digital circuit elements 118, electrically coupled together via the system bus 112. The system bus 112 typically comprises the physical and logical connections to couple the above-described elements together and enable their interoperability.

An input/output (I/O) element 121 is connected to the baseband subsystem 110 via connection 124. A memory element 128 is coupled to the baseband subsystem 110 via connection 129. The I/O element 121 typically includes, for example, a microphone, a keypad, a speaker, a pointing device, user interface control elements, a display device, and any other devices or system that allow a user to provide input commands and receive outputs from the C-A MD 100. The memory 128 may be any type of volatile or non-volatile memory, and in an embodiment, includes flash memory. The memory 128 may be permanently installed in the C-A MD 100, or may be a removable memory element, such as a removable memory card.

The processor 170 may be any processor capable of executing the computer code stored in memory 180. The computer code stored in memory 180 includes an establishment selection/notification program 200 and a Ca-A program 210, and typically also includes a browser program 211 and a database 212. The memory 180 may be volatile or non-volatile memory, but is typically a non-volatile memory. The C-A program 210 may be based on the Gimbal™ software development kit (SDK) from Qualcomm Labs, Inc., which is currently available in the market. Persons of skill in the art will understand how the Gimbal™ SDK can be used to create the C-A program 210 having the functionality described herein.

The analog circuitry 116 and the digital circuitry 118 include the signal processing, signal conversion, and logic that convert an input signal provided by the I/O element 121 to an information signal that is to be transmitted. Similarly, the analog circuitry 116 and the digital circuitry 118 include the signal processing elements used to generate an information signal that contains recovered information from a received signal. The digital circuitry 118 may include, for example, a digital signal processor (DSP), a field programmable gate array (FPGA), or any other processing device. Because the baseband subsystem 110 includes both analog and digital elements, it may be referred to as a mixed signal device (MSD).

The establishment selection/notification program 200 performs the tasks of selecting a particular establishment of a retail supplier and notifying the particular establishment of the selection. The database 212 stores contextual data related to the surroundings of the C-A MD 100. The C-A program 210 runs periodically or continuously and accumulates profile, history, and other real-time data, including information about the surroundings of the C-A MD 100 gathered by one or more of a variety of sensors of the C-A MD 100. The sensors include, for example, the antenna 160, a camera 161, a microphone 162, a Global Positioning System (GPS) sensor 163, an accelerometer 164, a gyroscope 165, and a digital compass 166.

Through the information gathered from one or more of these sensors 160-166 and analyzed by the C-A program 210 and through any other information that was previously acquired by or inputted into the C-A MD 100, the program 210 makes the C-A MD 100 aware of its surroundings, i.e., contextually aware. The contextual information of the C-A MD 100 may be enhanced with information regarding spatial relationships between the C-A MD 100 and a variety of establishments, as will now be described with reference to a few illustrative embodiments.

FIG. 2 is a pictorial illustration of a wireless network 300 in which a plurality of establishments 301a, 301b and 301c and a consumer 302 equipped with a C-A MD 100 are located. The establishments 301a, 301b and 301c may be conceptually related on a business or product basis, e.g. the establishments may me related the same retail entity (e.g., they may all be franchises having related trade dress). For example, the establishments 301a, 301b and 301c may all be fast food restaurants. Alternatively, establishments 301a, 301b and 301c may simply be restaurants that have agreed to accept orders from a C-A MD 100 The establishments 301a, 301b and 301c may be, but need not be, owned by the same person or entity. This example assumes that the C-A MD 100 displays icons on a touch screen display device (not shown) of the C-A MD 100 that represent application programs that the consumer 302 may cause to be executed by selecting the icon with a finger. One of these icons represents an application program that may be used to place an order with the establishments 301a, 301b and 301c.

When the consumer 302 selects the icon, the C-A MD 100 contacts the retail supplier associated with the establishments 301a, 301b and 301c. The contact between the C-A MD 100 and the retail supplier may be accomplished in a number of ways, including, for example, placing a telephone call to one of the establishments 301a, 301b, 301c, placing a telephone call to a main number associated with all of the establishments 301a, 301b, 301c, or setting up an Internet session with a server 305 of the retail supplier via the browser application 211 of the C-A MD 100. For exemplary purposes, it is assumed that establishments 301a, 301b, 301c and the server 305 have equipment (not shown for clarity) that is capable of communicating over the network 300 to allow a phone or Internet session to take place with the C-A MD 100.

Once a phone session or an Internet session has commenced between the C-A MD 100 and the retail supplier, the consumer 302 places an order with the retail supplier. In the case of a phone session, the order may be placed by the consumer 302 simply speaking the order to an employee of the retail supplier or into a voicemail system of the retail supplier. In the case of an Internet session, the consumer 302 places the order by making one or more selections on a website of the retail supplier via the I/O element 121 of the C-A MD 100.

In accordance with this example, it is assumed that the consumer 302 and the C-A MD 100 are moving together relative to the network 300, which is represented pictorially by cell towers 306 and a network cloud 307. As indicated above, the C-A MD 100 has functionality known as context awareness, which means that it is configured to analyze, by way of the C-A program 210, information obtained by one or more of its sensors 160-166 and other useful information acquired by the C-A MD 100 to generate data indicative of a context of the C-A MD 100 and/or the user thereof.

In accordance with this illustrative embodiment, the C-A program 210 uses information obtained by one or more of the sensors 160-166 to determine when the C-A MD 100 has passed through a geofence 317. The geofences 317 are perimeters around the establishments 301a, 301b and 301c. Each geofence 317 has a known spatial relationship with one or more of the establishments 301a, 301b and 301c. Based on the known spatial relationship between the C-A MD 100 and the establishments 301a, 301b and 301c, the establishment selection/notification program 200 determines which of the establishments 301a, 301b and 301c is most likely the establishment that the consumer 302 will arrive at to pick up the order. The establishment selection/notification program 200 uses the likelihood determinations to determine which of the establishments 301a, 301b and 301c the consumer 302 is most likely to arrive at ultimately to pick up the order.

For example, the likelihood determination may be based on the proximity of the C-A MD 100 to each of the establishments 301a-301c, e.g., whichever of the establishments 301a-301c is in closest proximity to the C-A MD 100 will be deemed to be the most likely establishment. This latter determination may be simply a determination that a particular one of the establishments 301a-301c currently has the closest proximity to the C-A MD 100 based on the most-recent geofence crossing, and therefore is most likely the establishment that the consumer 302 will ultimately arrive at to pick up the order. However, other information may be used for this purpose.

For example, position and heading information obtained from the GPS 163 and/or from the digital compass 166 may be used by the establishment selection/notification program 200 to determine which of the establishments 301a-301c the consumer 302 will most likely arrive at to pick up the order. The database 212 may include, for example, GPS coordinates for each of the establishments 301a-301c. The C-A MD 100 determines its own GPS coordinates from information obtained by the GPS sensor 163 and processed by the C-A program 210. By comparing the coordinates of the establishments 301a-301c with the coordinates of the C-A MD 100 over some period of time, the establishment selection/notification program 200 can determine the location of the C-A MD 100 relative to each of the establishments 301a-301c and the heading, or direction of travel, of the C-A MD 100.

Based on one or more of these types of information, the establishment selection/notification program 200 is able to determine which of the establishments 301a-301c the consumer 302 is most likely to arrive at to pick up the order. Based on this same information, the establishment selection/notification program 200 also calculates an estimated time of arrival of the consumer 302 at the particular establishment.

When the establishment selection/notification program 200 determines that a particular one of the establishments 301a-301c is the most likely candidate, the program 200 causes a notification to be sent to the particular establishment 301a-301c. For exemplary purposes, it will be assumed that establishment 301c has been determined by the C-A MD 100 to be the most likely establishment based on the C-A MD 100 being in closest proximity to establishment 301c. The notification that is sent to the establishment 301c notifies the establishment 301c of the order details and the consumer's identity (or other information that associates the consumer 302 with the order, such as the phone number of the C-A MD 100). The notification typically will also include the estimated pickup time. Based on this information, personnel at the particular establishment 301c can schedule and perform tasks associated with the order in a manner that ensures that the order is freshly prepared at the time that the consumer 302 arrives at the establishment 301c.

It may not be necessary in all cases for the C-A MD 100 to calculate an estimated time of arrival. For example, if the notifications are sent only when the C-A MD 100 crosses a geofence 317 that is known to be within a ten minute drive to the establishment 301c, and it takes about ten minutes to prepare all orders, personnel at the establishment 301c may simply start preparing the order at the time that the corresponding notification is received. In such cases, the estimated time of arrival does not need to be included in the notification.

It should be noted that the process described above may be an iterative process that continuously or periodically updates as the location of the consumer 302 relative to the establishments 301a-301c changes. Based on position and/or heading and/or other information processed by the C-A program 210, the establishment selection/notification program 200 may cancel a notification and issue a notification to a different one of the establishments if it determines that the likelihood determination has changed. For example, if it becomes less likely that the consumer 302 will ultimately arrive at establishment 301c and more likely that the consumer 302 will ultimately arrive at establishment 301b to pick up the order, then the C-A MD 100 may send a cancelation notification to establishment 301c and an order notification to establishment 301b.

In accordance with one illustrative embodiment, it is unnecessary for the consumer 302 to actually place the order because the C-A MD 100 causes the order to be placed when the establishment selection/notification program 200 determines that a particular one of the establishments 301a-301c is most likely the establishment at which the consumer 302 will ultimately arrive to pick up the order. The consumer 302 simply makes a selection via the I/O element 121, but the order is not placed at that time. The processor 170 stores the order in memory 180, typically in the database 212. Subsequently, as the consumer 302 travels over the network 300, the program 200 uses the context-awareness provided by program 210 to determine which of the establishments is most likely the establishment at which the consumer 302 will ultimately arrive to pick up the order.

When the program 200 makes the likelihood determination, it causes the C-A MD 100 to send the order to the particular establishment 301a-301c. For exemplary purposes, it will be assumed that establishment 301c has been determined by the C-A MD 100 to be the most likely establishment. The order that is sent to the establishment 301c informs the establishment 301c of the order details and the consumer's identity (or other information that associates the consumer with the order, such as the phone number of the C-A MD 100), for example. The order may also include an estimated pickup time. Based on this information, personnel at the particular establishment 301c can schedule and perform tasks associated with the order in a manner that ensures that the order is freshly prepared at the time that the consumer 302 arrives at the establishment 301c.

There may be situations in which the consumer 302 has not intentionally driven toward one of the establishments 301a-301c, but has merely entered an order via the I/O element of the C-A MD 100 and happens to be in close proximity to one of the establishments 301a-301c. Because of the closer proximity of the C-A MD 100 to one of the establishments than to the other of the establishments, the establishment selection/notification program 200 places the order with the closest establishment. In accordance with an embodiment, the GPS coordinates and driving directions to the closest establishment are displayed on the display device (not shown) of the C-A MD 100. This feature would be helpful in cases where the consumer is traveling in an area with which he is not familiar. This feature could also be used with the embodiments described above such that when the program 200 causes a notification to be sent to one of the establishment, the program 200 causes the GPS coordinates and driving directions to the establishment to be displayed on the display device (not shown) of the C-A MD 100.

The notifications, orders, estimated times of arrival, and any other information that is sent from the C-A MD 100 to one of the establishments 301a-301c may be sent in any format over any suitable communications medium of the network 300. Also, notifications, orders, estimated times of arrival, or other information sent to the establishments 301a-301c need not be sent directly to the establishments 301a-301c, but may be sent to some other device (e.g., server 305) of the network 300, which then forwards the information to the corresponding establishment 301a-301c. For example, the server 305 may act as a central repository that receives notifications, orders, estimated times of arrival, etc., and forwards the information to the corresponding establishment 301a-301c.

Typically, computer systems (not shown for clarity) located at the establishments 301a-301c cause the identity of the C-A MD 100 and/or of the identity of the consumer 302 to be displayed on display devices (not shown for clarity) of the computer systems along with the corresponding order and the estimated time of arrival of the consumer 302. The preparer will use this information to schedule and perform tasks associated with preparing orders to ensure that orders are freshly prepared when the consumer arrives at the establishment 301a-301c.

In addition to proximity, heading, and/or GPS coordinates being used by the establishment selection/notification program 200 to determine which establishment 301a-301c is the most likely establishment, additional information may be used to determine the likelihood that the consumer 302 will ultimately arrive at the establishment 301a-301c to pick up the order. For example, a reputation or reliability factor associated with the consumer 302 may be used to augment the likelihood determinations. In accordance with an embodiment, the program 200 performs an algorithm that takes into account a ratio of a number of times that an order has been placed with the retail supplier from the C-A MD 100 and picked up by the consumer to the total number of times that an order has been placed with the retail supplier from the C-A MD 100. This ratio may be used to augment the likelihood determination or to override the likelihood determination.

For example, if a likelihood determination based solely on proximity indicates a 70% probability that the consumer 302 will ultimately pick up an order at establishment 301c, but the reliability factor is only 50%, the preparer at establishment 301c may wait to begin preparing the order until the proximity-based information indicates a 90% probability that the consumer 302 will ultimately pick up the order at establishment 301c. As another example, a reliability factor may be used that is based on the number of times that an order has been placed by the C-A MD 100 with one of the establishments 301a-301c, but picked up at another of the establishments 301a-301c. For example, it will be assumed that at some point in time, the consumer 302 is in closest proximity to establishment 301c, but then at a later point in time, is in closest proximity to establishment 301a. This could happen for a variety of reasons.

For example, after placing an order, the consumer 302 drives to pick a child up from a school, which is located in close proximity to establishment 301c. After picking up the child, the consumer 302 drives in the direction of establishment 301a, which is located along the route that the consumer 302 normally takes when driving home. For exemplary purposes, it will be assumed that the establishment selection/notification program 200 first sends a notification that the order will be picked up at establishment 301c, but later sends a notification to establishment 301a. In this case, the reliability factor associated with the consumer 302 with respect to establishment 301c will be very low and will indicate that the consumer 301c rarely or never picks up an order from establishment 301c. If this reliability factor is transmitted along with the notification to establishment 301c, the preparer at the establishment 301c may disregard the notification due to the reliability factor being so low. On the other hand, the reliability factor associated with the consumer 302 picking up orders from establishment 301a will be very high and will indicate a high likelihood that the consumer 302 will ultimately arrive at the establishment 301a to pick up the order. Therefore, after receiving the notification at establishment 301a, the preparer at establishment 301a will begin preparing the order in anticipation of the arrival of the consumer 302. Thus, the reliability or reputation factor may be used to augment or override the likelihood determination.

In addition to using the spatial relationships and/or the reliability factor to determine which establishment is the likely establishment, additional contextual information may be used for this purpose. For example, the establishment that is in closest proximity to the C-A MD 100 is not necessarily the closest establishment in terms of driving time. The C-A MD 100 is capable of determining that the consumer 302 is traveling on foot or in a vehicle based on the speed at which the consumer 302 is traveling by using information sensed by one or more of the sensors 160-166. The C-A MD 100 is also capable of gathering information about traffic conditions from various reports that are issued over the network 300. The C-A MD 100 may use such information to determine that the consumer 302 will likely choose an establishment 301a-301c that is not necessarily closest in proximity to the C-A MD 100, but is closest in time in terms of the length of time that it will take to drive to the establishment 301a-301c.

The aforementioned spatial relationships between the C-A MD 100 and the establishments 301a, 301b, 301c are typically part of the context that is constructed by the C-A program 210. The context is not limited with respect to the types or amounts of information that are used by the C-A program 210 to construct the context. Any information that is acquired by, collected by or inputted into the C-A MD 100 can be used by the C-A program 210 to build the context. The C-A program 210 may use a variety of types of inputs (both current and historical) such as, for example, location, time of day, spatial relationships, and previous purchases to determine its context. These inputs are combined by the C-A program 210 and used by it to enable the C-A MD 100 to understand its surroundings in order to personalize and bring more relevance to the task that the user is performing.

Contextual information, however, is not limited to information obtained by the sensors 160-166. Contextual information can include any information of any type acquired in any manner that is usable by the C-A MD 100 to construct the context. For example, context can include historical information about past activities of the user, such as, for example, places the user has visited, purchases the user has made, and routes the user has traveled. Context may also include profile information about the user, such as, for example, home address, work address, age of the user, the address of the user's gym, the address of a grocery store at which the user frequently shops, and other personal information. Some of the historical information and profile information may have been acquired by one or more of the sensors 160-166, whereas some of the historical and profile information may be information that has been inputted to the C-A MD 100 (e.g., via user via I/O interface 121) and stored in memory 180. In addition, contextual information may include information that was pre-stored in memory 180 (i.e., stored in memory 180 prior to the C-A MD 100 being shipped or sold to an original user), such as, for example, GPS coordinates of places. In addition, contextual information that is stored in memory 180 may be static information that does not change or it may be dynamic information that is updated continuously or periodically by the C-A program 210.

Although the spatial relationships between the C-A MD 100 and the establishments 301a, 301b, 301c are typically part of the context, and therefore are known to the C-A MD 100, other or additional contextual information may be used to determine which of the establishments 301a, 301b or 301c is a likely or convenient establishment for the user. For example, the current location of the C-A MD 100 in combination with a geofence crossing in combination with a past history of similar movement can lead to an inference that a particular one of the establishments 301a, 301b or 301c is a convenient or likely establishment for the user.

FIG. 3 is a flowchart that demonstrates the method performed by the C-A MD 100 in accordance with an illustrative embodiment. In accordance with this embodiment, the consumer uses a C-A MD to place an order with a retail entity (e.g., retail supplier or franchisor) that is associated with multiple establishments, as indicated by block 401. The C-A MD periodically or continuously runs a C-A program that processes information sensed by at least one sensor of the C-A MD to make the C-A MD contextually aware, as indicated by block 402. Although the C-A algorithm has been described as being implemented as a software program being executed by a processor, the C-A functionality may be implemented in hardware, software, firmware, or a combination thereof.

The C-A MD periodically or continuously runs an establishment selection/notification program that uses the contextual awareness to determine which of the establishments the consumer will likely arrive at to pick up the order, as indicated by block 403. Although the establishment selection/notification algorithm has been described as being implemented as a software program being executed by a processor, this algorithm may be implemented in hardware, software, firmware, or a combination thereof. Also, although the C-A algorithm and the establishment selection/notification algorithm have been described as being separate algorithms that work together, they may be part of the same algorithm.

After a determination has been made as to which of the establishments the consumer will likely arrive at to pick up the order, the establishment selection/notification program causes the C-A MD to send a notification to the particular establishment to notify the particular establishment that the consumer is likely to pick up an order, as indicated buy block 404. The notification includes the order, or an identifier associated with an order, and/or the identity associated with the consumer or the consumer's C-A MD. The notification typically also includes an estimated time of arrival of the consumer at the particular establishment.

Based on this information, the preparer at the particular establishment may schedule and perform tasks associated with preparing the order so that the order is freshly prepared when the consumer arrives to pick up the order.

FIG. 4 is a flowchart that demonstrates the method performed by the C-A MD 100 in accordance with the above-described illustrative embodiment in which the C-A MD 100 places an order with a likely establishment. In accordance with this embodiment, the consumer uses an input device of the C-A MD to input an order into the C-A MD that may be serviced by any of a plurality of establishments associated with a retail entity, as indicated by block 501. The C-A MD periodically or continuously runs a C-A program that processes information sensed by at least one sensor of the C-A MD to make the C-A MD contextually aware, as indicated by block 502.

The C-A MD periodically or continuously runs an establishment selection/notification program that uses the contextual awareness to determine which of the establishments the consumer will likely arrive at to pick up the order, as indicated by block 503. After the establishment selection/notification program has determined which of the establishments the consumer will likely arrive at to pick up the order, the establishment selection/notification program causes the C-A MD to send the order to the particular establishment to notify the particular establishment that the consumer is likely to pick up an order, as indicated buy block 504. The order includes the identity associated with the consumer or with the consumer's C-A MD. The order typically also includes an estimated time of arrival of the consumer at the particular establishment.

Based on this information, the preparer at the particular establishment may schedule and perform tasks associated with preparing the order so that the order is freshly prepared when the consumer arrives to pick up the order.

Although the C-A algorithm and the establishment selection/notification algorithm have been described with reference to FIG. 4 as being implemented in software executed by a processor, the corresponding functionality may be implemented in hardware, software, firmware, or a combination thereof. Also, although the C-A algorithm and the establishment selection/notification algorithm have been described with reference to FIG. 4 as being separate algorithms that work together, they may be part of the same algorithm.

FIG. 5 is a flowchart that demonstrates the method shown in FIG. 3, but with the additional step of using the aforementioned reputation or reliability factor to augment or override the likelihood determination. In accordance with this embodiment, the consumer uses a C-A MD to place an order with a retail entity (e.g., retail supplier or franchisor) that is associated with multiple establishments, as indicated by block 601. The C-A MD periodically or continuously runs a C-A program that processes information sensed by at least one sensor of the C-A MD to make the C-A MD contextually aware, as indicated by block 602. The C-A MD periodically or continuously runs an establishment selection/notification program that uses the contextual awareness to determine which of the establishments the consumer will likely arrive at to pick up the order, as indicated by block 603.

After the establishment selection/notification program has determined the likely establishment, it retrieves a reputation or reliability factor associated with the consumer or the C-A MD from the memory of the C-A MD and processes the reliability factor to determine which of the establishments is the likely establishment, as indicated by block 604. The manner in which the reliability factor may be used to augment or override the likelihood determination made at block 603 has already been described above with reference to a few exemplary embodiments.

After a determination has been made as to which of the establishments the consumer will likely arrive at to pick up the order, the establishment selection/notification program causes the C-A MD to send a notification to the particular establishment to notify the particular establishment that the consumer is likely to pick up an order, as indicated buy block 605. The notification includes the order, or an identifier associated with an order, and/or the identity associated with the consumer or the consumer's C-A MD. The notification typically also includes an estimated time of arrival of the consumer at the particular establishment.

Based on this information, the preparer at the particular establishment may schedule and perform tasks associated with preparing the order so that the order is freshly prepared when the consumer arrives to pick up the order.

In accordance with another illustrative embodiment, the C-A MD 100 presents retail establishment options to the consumer based on historical data that has been logged by the C-A MD 100 over time. For example, the consumer may execute a food-ordering application program on the C-A MD 100 that is used for ordering food. Alternatively, the consumer may use the web browser program 211 to go to a website that executes the food-ordering program. For exemplary purposes, it will be assumed that the food-ordering program requires only a time of day at which the consumer wishes to pick up the order. It will also be assumed, for exemplary purposes, that the C-A program 210 logs historical information in database 212 that identifies travel routes that the consumer takes each day, the most likely travel route that the consumer will take on any given day, a number of retail food establishments along each travel route, and a window of time each day during which the consumer passes each of the establishments.

Given the time of day at which the consumer wishes to pick up the order, the establishment selection/notification program 200 will select one or more retail establishments along the most likely travel route that the consumer passes during a window of time that includes the time of day that the consumer wishes to pick up the food order. The establishment selection/notification program 200 then causes the retail establishment options to be displayed on the display device 122 (FIG. 1). The consumer will then select one of the retail establishments. Making the selection may cause a menu for the establishment to be displayed to the consumer on display device 122. The consumer then places an order by making selections from the menu. Later that day as the consumer travels, the processes represented by blocks 402 and 404 in FIG. 3 are performed by the C-A MD 100 so that the order is freshly prepared when the consumer arrives at the establishment to pickup the order.

FIG. 6 is a flowchart that demonstrates the method performed by the C-A MD 100 in accordance with the above-described illustrative embodiment. The consumer causes a food-ordering program to be executed that prompts the consumer to enter an anticipated pickup time into the C-A MD 100 at which the consumer expects to pick up a food order, as indicated by block 701. The consumer then inputs the anticipated time of day into the C-A MD 100, as indicated by block 702. The establishment selection/notification program 200 then uses the historical data contained in memory 180 in combination with the inputted pickup time to determine a most likely travel route and to select one or more retail establishments along the most likely travel route, as indicated by block 703. The establishment selection/notification program 200 then causes the retail establishment options to be displayed on the display device 122, as indicated by block 704. The consumer will then select one of the retail establishments, as indicated by block 705. Making the selection may cause a menu for the establishment to be displayed to the consumer on display device 122, as indicated by block 706. It should be noted that the various menu items may be displayed without requiring the user to select a particular establishment. In this case, initial selection of a menu item may limit further selection to additional items from the same restaurant. The consumer then places an order by making selections from the menu, as indicated by block 707.

Later that day as the consumer travels, a process similar to the processes represented by blocks 402-404 in FIG. 3 or blocks 502-504 in FIG. 4 is performed by the C-A MD 100 so that the order is freshly prepared when the consumer arrives at the establishment to pickup the order. Specifically, the C-A program 210 senses its surroundings and determines its proximity to the selected establishment, as indicated by block 708. When the consumer is in relatively close proximity to the selected establishment, the establishment selection/notification program 200 causes the notification to be sent to the selected establishment, as indicated by block 709. The term “relatively close proximity” means within a distance that will allow the preparer to have sufficient time to prepare the order. Factors other than, or in addition to, distance may be taken into account in determining when the C-A MD is in close proximity to the selected establishment, such as the speed at which the C-A MD is traveling, traffic along the route of travel, the amount of time that is required to prepare the order, etc.

It should be noted that many variations may be made to the process described above with reference to FIG. 6 within the scope of the invention. For example, the food-ordering computer program executed in block 701 may prompt the consumer to enter a food type in lieu of, or in addition to, entering an anticipated pickup time. If the consumer on most days takes the same travel route home from the workplace at generally the same time of day, the historical data collected by the C-A program 210 will indicate that the consumer passes by certain retail food establishments within certain windows of time on certain days of the week. In such cases, the food-ordering program may simply display food types as options at block 701, such as, for example, icons representing a sandwich/chips/drink combination, a hamburger/fries/drink combination, a copy of coffee, a steak dinner, a fish dinner, etc. The consumer would then select the food type at block 702 instead of, or in addition to, inputting an anticipated pick-up time. In this case, the process performed at block 703 would entail determining which retail establishment along the most likely travel route serves the selected food type. If there is more than one option, the processes represented by blocks 704, 705, 708, and 709 would not change, but the processes represented by blocks 706 and 707 could be eliminated since the selection was already made at block 702, although these processes could be performed to enable the consumer to specify more details about the order and/or to specify a retail establishment.

Many other variations to the process represented by the flowchart of FIG. 6 are possible. For example, at some point during the process, the C-A MD may cause driving directions and the anticipated pickup time to be displayed on the display device 122 of the C-A MD 100, such as at the time that the notification is sent to the retail establishment at the step represented by block 709. This would serve dual purposes of providing the consumer with driving directions to the retail establishment as well as reminding the consumer that they placed an order at the retail establishment for a particular pickup time. Another purpose for this is that it could provide the consumer with the opportunity to cancel or modify the order and/or reschedule the pickup time.

After any of the processes represented by the flowcharts of FIGS. 3, 4, 5 and 6 have been performed, a preparer at the particular establishment prepares the order such that the order is freshly prepared when the consumer arrives to pick up the order. In accordance with an illustrative embodiment, a host computer located at the retail establishment receives the notification, schedules the preparation tasks that will be performed by the preparer, and displays the preparation tasks on one or more display devices for viewing by the preparer. An illustrative embodiment of the host computer and method will now be described with reference to FIGS. 7 and 8.

FIG. 7 is a block diagram of a host computer 810 and a display device 820 that are located at a retail food establishment. The host computer 810 executes an order scheduling computer program 830 that (1) receives the notification sent in blocks 404, 504, 605, or 709, (2) schedules the preparation tasks associated with the order, and (3) displays the schedules on the display device 820 for viewing by the preparer. Because different food products will typically take different amounts of time to prepare, the program 830 preferably associates each food product order with a preparation time period and displays this association on the display device 820. This association may be created through the use of a lookup table (LUT) 850 that is part of a memory device 840. To accomplish this, each notification that is sent in blocks 404, 504, 605, and 709 typically includes one or more identifiers that identify the food products of each order. The program 830 uses each identifier to address the LUT 850. Each address of the LUT 850 contains a preparation time period for the associated food product. The preparation time period is an amount of time that is required to prepare the food product.

In accordance with an illustrative embodiment, the program 830 uses the identifiers contained in the notification to obtain the corresponding preparation time periods from the LUT 850. The program 830 uses the estimated arrival times of the consumers and the associated preparation time periods of the orders to schedule the preparation tasks that need to be performed to prepare the food products of each order. The program 830 then notifies the preparer when to start preparing the food products of the orders. This can be accomplished in a number of ways, so the invention is not limited with respect to the manner in which this is accomplished.

One way of accomplishing this is to display the food product identifier and an order identifier that associates the food product with the consumer's order on the display device 820 when it is time for the preparer to begin preparing the food product, i.e., when the amount of time that it takes to prepare the food product is equal to the amount of time that remains before the consumer will arrive to pick up the order. The preparer would then start preparing the food products as soon as they appear on the display device 820. An audible notification may be used in lieu of, or in addition to, the visual notification being displayed on the display device 820.

Another way to accomplish this is to simply display all of the orders along with the expected pickup times on the display device and remove orders from the display device as they are completed. If it can be assumed that the preparer knows with reasonable certainty how long it takes to prepare an order, then it is unnecessary to also display the amount of time that is required to prepare the food products of the order. In such cases, it may be sufficient to simply display the orders along with the corresponding consumers' identities and the expected pickup times. Based on this information, the preparer can time the preparation of the order such that the order is freshly prepared at the expected pickup time.

Because it may not be possible to display all pending orders simultaneously on the display device 820, the program 830 may load the food product identifiers and the corresponding preparation time periods into a queue 860 of memory device 840 such that food products having longer preparation time periods are closer to the top of the queue 860 and food products having shorter preparation times are closer to the bottom of the queue 860. In this case, the program 830 unloads the orders from the top of the queue 860 and sends them to the display device 820 after the previous order is completed. The program 830 may delay sending orders from the queue 860 to the display device 820 until a point in time that is in advance of the expected pickup time by a timer period equal to the amount of time that it takes to prepare the order. In either case, the program 830 schedules preparation of the order by causing the order to be displayed on the display device 820 at an appropriate point in time. In this example, it is assumed that previous orders are removed from the display device 820 once they have been completed.

FIG. 8 is a flowchart that represents an illustrative embodiment of the process performed by the host computer 810 running the scheduling program 830, the display device 820, and the memory device 840. The host computer 810 running the scheduling program 830 receives the notification of the order sent by the MD (e.g., notifications sent in any of blocks 404, 504, 605, and 709), as indicated by block 901. Based on the contents of the order, the estimated pickup time and the amount of time that it takes to prepare the order (obtained from memory 840), the host computer 810 schedules preparation of the order, as indicated by block 902. The host computer 810 then causes the preparation schedule to be displayed on the display device 820, as indicated by block 903.

In cases where the C-A algorithm and the establishment selection/notification algorithm are implemented in software or firmware, the corresponding code is stored in the memory 180, which is a computer-readable medium. The memory 180 is typically is a solid state computer-readable medium, such as a non-volatile random access memory (RAM), read only memory (ROM) device, programmable ROM (PROM), erasable PROM (EPROM), etc. However, other types of computer-readable mediums may be used for storing the code, such as, for example, magnetic and optical storage devices. The scheduling computer program 830 is typically also implemented in software that is stored in memory 840, which is also a computer-readable medium of one or more of the aforementioned types.

It should be noted that although the systems and methods have been described in connection with ensuring that perishables products are freshly prepared when the consumer arrives to pick them up, the systems and methods are also applicable in other areas. For example, the principles and concepts described above could also be applied to ensure that emergency rooms at care facilities are made ready for patients at the time of arrival or to ensure that complex rentals are made ready for renters as they arrive to rent them. These concepts and principles may also be used for workforce management (e.g., field technicians) and in other industries.

It should also be noted that many variations may be made to the methods described above with reference to FIGS. 1-8 without deviating from the scope of the invention. For example, some of the tasks that have been described above with reference to FIGS. 3-5 as being performed by the C-A MD 100 may instead be performed by some other device that is coupled to the network 300, such as server 305 or some other device. Also, the C-A MD 100 is merely one example of a mobile device that has a suitable configuration and functionality for performing the methods. Persons of skill in the art will understand, in view of the description provided herein, that many variations may be made to the C-A MD shown in FIG. 1 and to the methods shown in FIGS. 3-6 and 8 without deviating from the scope of the invention. These and other variations are within the scope of the invention. The illustrative embodiments described herein are intended to demonstrate the principles and concepts of the invention, but the invention is not limited to these embodiments, as will be understood by those of skill in the art.

What is claimed is:

1. A method for ordering an item on a mobile device, the method comprising:
on the mobile device, receiving an order from a user of the mobile device, the order specifying an item requiring preparation time and being available at a plurality of establishments;
determining spatial relationships between the mobile device and each of the plurality of establishments;
determining one of the plurality of establishments for the user to pick up the order based at least in part on the determined spatial relationships; and
transmitting from the mobile device a pickup order for the item to be picked up at the determined one of the plurality of establishments.

2. The method of claim 1, wherein the mobile device uses a context of the mobile device to determine the one of the plurality of establishments.

3. The method of claim 1, wherein the determining of the spatial relationships is further based on geofences associated with the establishments.

4. The method of claim 2, further comprising:
estimating, based at least in part on the spatial relationships, an arrival time of the user of the mobile device at the particular establishment and transmitting the estimated arrival time from the mobile device to the determined one of the plurality of establishments.

5. The method of claim 2, wherein the context of the mobile device is determined using one or more sensors of the mobile device including a radio frequency (RF) sensor, a Global Positioning System (GPS) sensor, an accelerometer, a camera, a gyroscope, a microphone, and a digital compass.

6. The method of claim 1, wherein the item comprises a prepared food item.

7. The method of claim 1, wherein each of the establishment comprises a restaurant.

8. The method of claim 1, wherein the plurality of establishments are similarly branded restaurants.

9. The method of claim 1, further comprising:
on the mobile device, evaluating a reliability factor associated with the mobile device to determine the one of the plurality of establishments.

10. A method for ordering an item on a mobile device, the method comprising:
on the mobile device, receiving an order from a user of the mobile device and causing the order to be placed with a retail entity associated with a plurality of establishments;
on the mobile device, determining spatial relationships between the mobile and each of the plurality of establishments;
on the mobile device, determining one of the establishments convenient for the user to pick up the order based at least in part on the spatial relationships; and
on the mobile device, transmitting a notification over a network to notify the determined one of the plurality of establishments that the user of the mobile device will arrive at the determined one of the plurality of establishments.

11. The method of claim 10, further comprising:
prior to the mobile device transmitting the notification, using the spatial relationships in the mobile device to estimate a point in time at which the user of the mobile device is likely to arrive at the determined one of the plurality of establishments to pick up the order; and wherein the notification includes the estimated arrival time.

12. The method of claim 10, wherein the mobile device further uses a context of the mobile device to determine one of the establishments convenient of the user to pick up the order.

13. The method of claim 12, wherein the determining of one of the plurality of establishments is further based on geofences associated with the establishments.

14. The method of claim 12, wherein the context of the mobile device is based at least in part on information obtained by one or more sensors of the mobile device including a radio frequency (RF) sensor, a Global Positioning System (GPS) sensor, an accelerometer, a camera, a gyroscope, a microphone, and a digital compass.

15. The method of claim 10, further comprising:
on the mobile device, evaluating a reliability factor associated with the user of the mobile device to determine the one of the plurality of establishments.

16. A mobile device comprising:
an input/output (I/O) interface;
at least one input element coupled to the I/O interface for receiving input entered on the input element by a user;
a radio frequency (RF) subsystem configured to allow the mobile device to communicate wirelessly over a telecommunications network, the RF subsystem including an RF antenna, a receiver (Rx) module and a transmitter (Tx) module;
at least one memory device, the memory device having pickup order data stored therein corresponding to a pickup order entered by the user on the input element; and
at least one processor electrically coupled to the I/O interface, to the RF subsystem and to the memory device, the processor being configured to determine spatial relationships between the mobile device and each of a plurality of establishments, and wherein the processor uses the spatial relationships to determine one establishment of the plurality of establishments that is convenient for the user and transmits the pickup order to the determined one of the plurality of establishments.

17. The mobile device of claim 16, wherein the processor uses the spatial relationships to estimate a point in time at which the user of the mobile device is likely to arrive at the determined one of the plurality of establishments and transmits the estimated arrival time to the determined one of the plurality of establishments.

18. The mobile device of claim 17, wherein the estimated arrival time is based at least in part on a determination by the processor that the mobile device has crossed at least one geofence.

19. The mobile device of claim 16, wherein the processor uses a context of the mobile device to determine the one establishment of the plurality of establishments that is convenient for the user.

20. The mobile device of claim 19, further comprising:
at least one of a Global Positioning System (GPS) sensor, an accelerometer, a camera, a gyroscope, a microphone, and a digital compass, and wherein the context of the mobile device is based at least in part on information obtained by one or more of the RF antenna, the GPS sensor, the accelerometer, the camera, the gyroscope, the microphone, and the digital compass.

21. The mobile device of claim 16, wherein the processor further uses a reliability factor associated with the user of the mobile device in determining the one of the plurality of establishments.

22. A mobile device comprising:
an input/output (I/O) interface;
at least one input element coupled to the I/O interface for receiving input entered on the input element by a user;
a radio frequency (RF) subsystem configured to allow the mobile device to communicate wirelessly over a telecommunications network, the RF subsystem including an RF antenna, a receiver (Rx) module and a transmitter (Tx) module;
at least one memory device; and
at least one processor electrically coupled to the I/O interface, to the RF subsystem and to the memory device, the processor being configured to determine spatial relationships between the C-A MD and each of a plurality of establishments associated with the retail entity and to use at least the spatial relationships to determine one establishment of the plurality of establishments convenient to the user of the mobile device to pick up a pickup order that was previously placed by the mobile device, and wherein the mobile device transmits a notification to the determined one of the plurality of establishments that the user will arrive at the determined one of the plurality of establishments to pick up the previously-placed order.

23. The mobile device of claim 22, wherein the processor uses the spatial relationships to estimate a point in time at which the user of the mobile device is likely to arrive at the particular establishment and includes the estimated arrival time in the notification.

24. The mobile device of claim 23, wherein the processor uses a context of the mobile device to determine one establishment of the plurality of establishments that is convenient for the user.

25. The mobile device of claim 22, wherein the processor uses geofences to determine the spatial relationships.

26. The mobile device of claim 24, further comprising:
at least one of a Global Positioning System (GPS) sensor, an accelerometer, a camera, a gyroscope, a microphone, and a digital compass, and wherein the context of the mobile device is based at least in part on information obtained by one or more of the RF antenna, the GPS sensor, the accelerometer, the camera, the gyroscope, the microphone, and the digital compass.

27. The mobile device of claim 22, wherein the processor further uses a reliability factor associated with the user of the mobile device in determining the one of the plurality of establishments.

28. A non-transitory computer-readable medium having computer code stored thereon for execution by a processor of a mobile device for ordering an item on the mobile device, the computer-readable medium comprising:
a first code segment that receives input entered by a user on an input element of the mobile device;
a second code segment that stores a representation of the entered input in a memory of the mobile device, the representation stored in the memory corresponding to a pickup order to be placed with a retail entity;
a third code segment that determines spatial relationships between the mobile device and each of a plurality of establishments associated with the retail entity;
a fourth code segment that uses the spatial relationships to determine one of the plurality of establishments that is convenient for the user to pick up an order; and
a fifth code segment that causes the mobile device to place a pickup order with the determined one of the plurality of establishments corresponding to the representation stored in memory.

29. The non-transitory computer-readable medium of claim 28, further comprising:
a sixth code segment that uses the spatial relationships determined by the third code segment to estimate a point in time at which the user of the mobile device is likely to arrive at the particular establishment; and
a seventh code segment that causes the mobile device to send the estimated arrival time to the particular establishment.

30. The non-transitory computer-readable medium of claim 28, wherein the fourth code segment uses a context of the mobile device to determine the one of the plurality of establishments that is convenient for the user to pick up an order.

31. The non-transitory computer-readable medium of claim 28, wherein the third code segment determines the spatial relationships based at least in part on geofences.

32. The non-transitory computer-readable medium of claim 30, wherein the context is based at least in part on information obtained by one or more sensors of the mobile device to make the mobile device aware of surroundings of the mobile device, and wherein said one or more sensors include one or more of a radio frequency (RF) antenna, a Global Positioning System (GPS) sensor, an accelerometer, a camera, a gyroscope, a microphone, and a digital compass.

33. The non-transitory computer-readable medium of claim 29, wherein the sixth code segment uses geofences having known spatial relationships to the establishments to determine the estimated arrival time.

34. A non-transitory computer-readable medium having computer code stored thereon for execution by at least one processor of a mobile device for ordering an item on the mobile device, the computer-readable medium comprising:
a first code segment that receives input entered by a user on an input element of the mobile device;
a second code segment that causes the mobile device to place a pickup order associated with the entered input with a retail entity associated with a plurality of establishments;
a third code segment that determines spatial relationships between the mobile device and each of the establishments;
a fourth code segment that uses the spatial relationships to determine one establishment of the plurality of establishments that is convenient to the user; and
a fifth code segment that sends a notification from the mobile device over the network to notify the one of the plurality of establishments of a likely arrival of the user of the mobile device at the one of the plurality of establishments.

35. The non-transitory computer-readable medium of claim 34, further comprising:
a sixth code segment that uses the spatial relationships determined by the third code segment to estimate a point in time at which the user of the mobile device is likely to arrive at the one of the plurality of establishments to pick up the order, and wherein the notification includes the estimated arrival time.

36. The non-transitory computer-readable medium of claim 34, wherein the fourth code segment uses a context of the mobile device to determine the one establishment of the plurality of establishments that is convenient for the user.

37. The non-transitory computer-readable medium of claim 35, wherein the sixth code segment estimates the arrival time based at least in part on geofences having known spatial relationships to each of the establishments.

38. The computer-readable medium of claim 36, wherein the context of the mobile device is based at least in part on information obtained by one or more sensors of the mobile device including one or more of a radio frequency (RF) antenna, a Global Positioning System (GPS) sensor, an accelerometer, a camera, a gyroscope, a microphone, and a digital compass.

39. A method for ordering an item on a mobile device, the method comprising:
in a mobile device, receiving an item order entered into the mobile device by a user of the mobile device;
in the mobile device, using historical data collected by the mobile device over time to determine one or more retail establishments along a travel route that is convenient to the user;
on the mobile device, displaying said one or more retail establishments on a display device of the mobile device;
in the mobile device, detecting a selection by the user of one of said one or more retail establishments; and
with the mobile device, transmitting a pickup order of the item with the selected retail establishment.

40. The method of claim 39, further comprising:
in the mobile device, after detecting the selection of the retail establishment and before transmitting the pickup order, displaying a menu of food product items associated with the selected retail establishment on the display device; and
in the mobile device, detecting a selection by the user of at least one of the displayed food product items, wherein the transmitted pickup order includes the selected food product.

41. A mobile device comprising:
an input/output (I/O) interface;
at least one input element coupled to the I/O interface for receiving input entered on the input element by a user of the mobile device;
a radio frequency (RF) subsystem configured to allow the C-A MD to communicate wirelessly over a telecommunications network, the RF subsystem including an RF antenna, a receiver (Rx) module and a transmitter (Tx) module;
at least one memory device having historical data stored therein associated with travel routes and retail establishments along the travel routes; and
at least one processor electrically coupled to the I/O interface, to the RF subsystem and to the memory device, the processor being configured to collect the historical data, and wherein the processor uses the historical data in combination with an estimated pickup time entered on the input device by the user to determine one of the retail establishments that is convenient to the user and causes the mobile device to transmit an order to the determined one of the retail establishments.

42. A method for use by a retail establishment for scheduling preparation tasks associated with preparing a pickup order, the method comprising:
in a host computer of a computer system located at the retail establishment:
receiving a notification from a mobile device that a user will arrive at the establishment to pick up a pickup order;
creating a schedule of preparation tasks associated with preparing at least one food product of the pickup order; and
displaying the schedule on a display device of the computer system for viewing by a preparer of said at least one food product.

43. A computer system located at a retail establishment for scheduling preparation tasks associated with preparing a pickup order, the computer system comprising:
a display device;
a memory device; and
a host computer, the host computer executing an order scheduling computer program that:
receives a notification from a mobile device that a user will arrive at the establishment to pick up a pickup order;
creates a schedule of preparation tasks associated with preparing at least one food product of the pickup order; and
displays the schedule on the display device for viewing by a preparer of said at least one food product.

44. The method of claim 1, further comprising:
estimating and arrival time of the user at the determined one of the plurality of establishments; and
wherein the step of transmitting the pickup order is performed when the estimated arrival time coincides with a preparation time of the item.
